(19) United States
(12) Patent Application Publication
(10) Pub. No.: US 2023/0325885 A1
(43) Pub. Date: Oct. 12, 2023

(54) ADVERTISEMENT DISTRIBUTION SYSTEM, ADVERTISEMENT DISTRIBUTION APPARATUS, ADVERTISING RATE DETERMINATION APPARATUS, AND ADVERTISEMENT DISTRIBUTION METHOD

(71) Applicant: NEC Corporation, Minato-ku, Tokyo (JP)

(72) Inventor: Michihiko YUSA, Tokyo (JP)

(73) Assignee: NEC Corporation, Minato-ku, Tokyo (JP)

(21) Appl. No.: 18/022,842

(22) PCT Filed: Aug. 28, 2020
(86) PCT No.: PCT/JP2020/032767

§ 371 Date: Feb. 23, 2023

(51) Int. Cl. G06Q 30/0273

(52) U.S. Cl. CPC G06Q 30/0273

(57) ABSTRACT

An advertisement determination unit determines an advertisement to be displayed on an advertisement display apparatus. An analyzing unit obtains sensor information from a sensor and performs analysis of traffic conditions including a traveling speed of each of the vehicles traveling on the road. A unit price determining unit determines, based on the traffic conditions, a unit price of the advertisement to be displayed on the advertisement display apparatus. An advertising rate calculation unit calculates an advertising rate based on a track record of the advertisement displayed on the advertisement display apparatus and the unit price determined by the unit price determination unit.

### TECHNICAL FIELD

The present disclosure relates to an advertisement distribution system, an advertisement distribution apparatus, an advertising rate determination apparatus, an advertising rate determination method, and a computer-readable medium.

### BACKGROUND ART

Digital signage displays are known for displaying advertisements. A digital signage display has a display device, such as a liquid crystal display panel. Digital signage displays are configured to display advertising contents such as videos or still images. The advertising contents to be displayed on a digital signage display can be switched depending on the place where the digital signage display is installed and the time at which the advertising contents are displayed. Therefore, digital signage displays allow for distribution of advertisements that are focused on a target audience.

As a related art, Patent Literature 1 discloses an advertising rate determination apparatus. The advertising rate determination apparatus described in Patent Literature 1 determines the advertising rates for displaying advertisements along a road. The advertising rate determination apparatus described in Patent Literature 1 registers the roadside land price of a road expressed in numeric values and the traffic volume of the road in a database. The advertising rate determination apparatus calculates the basic rate for displaying an advertisement along a road based on the roadside land price of the road expressed in numeric values. The advertising rate determination apparatus multiplies the calculated basic rate by a factor based on the traffic volume per hour on the road expressed in numeric values.

As another related art, Patent Literature 2 discloses a digital signage control device. A digital signage control device acquires traffic condition-related information which is information about the traffic condition in the vicinity of each of a plurality of digital signage displays. Based on the traffic condition-related information, the digital signage control device assesses the traffic volume, the traveling speed of vehicles, and the like on the roads in the vicinity of a digital signage and predicts an effectiveness indicator which is equivalent to an impression made by the digital signage on a target audience. The digital signage control apparatus switches display of an advertisement displayed on a digital signage to another digital signage in the case where a predicted value of the effectiveness indicator is below an expected standard. Patent Literature 3 is another related art using a digital signage.

### CITATION LIST

### Patent Literature

Patent Literature 1: Japanese Unexamined Patent Application Publication No. 2012-168576
Patent Literature 2: Japanese Unexamined Patent Application Publication No. 2019-036049
Patent Literature 3: Japanese Unexamined Patent Application Publication No. 2018-013514

### SUMMARY OF INVENTION

### Technical Problem

The advertising rate determination apparatus described in Patent Literature 1 uses a coefficient based on the traffic volume data for calculation of the advertising rate. The advertising rate determination apparatus can increase the advertising rates for roads with high traffic volume and decrease the advertising rates for roads with low traffic volume. However, in the technique described in Patent Literature 1, the advertising rates are varied based on only the traffic volume.

The digital signage control apparatus described in Patent Literature 2 can switch display of the advertising information displayed on a digital signage to another digital signage in the case where a predicted value of the effectiveness indicator is below an expected standard. However, Patent Literature 2 aims to control decline in the advertising effectiveness. Patent Literature 2 does not disclose about varying the advertising rates based on the traffic conditions.

The present disclosure has been made in view of the above and object of the present disclosure is to provide an advertisement distribution system, an advertisement distribution apparatus, an advertising rate determination apparatus, an advertising rate determination method, and a computer-readable medium, each adapted to enable determination of advertising rates based on the traffic conditions, in particular, based on the traveling speed of vehicles.

### Solution to Problem

In order to attain the aforementioned object, the present disclosure provides an advertisement distribution apparatus. An advertisement distribution apparatus includes: advertisement determination means for determining an advertisement to be displayed on an advertisement display apparatus that is installed in such a way that it is viewable from vehicles traveling on a road; analyzing means for obtaining sensor information from a sensor installed along a side of the road and performing analysis of traffic conditions including a traveling speed of each of the vehicles traveling on the road; unit price determining means for determining, based on the analyzed traffic conditions, a unit price of the advertisement to be displayed on the advertisement display apparatus; and advertising rate calculation means for calculating an advertising rate based on a track record of the advertisement displayed on the advertisement display apparatus and the unit price determined by the unit price determining means.

Further, the present disclosure provides an advertising rate determination apparatus. An advertising rate determination apparatus includes: analyzing means for obtaining sensor information from a sensor installed along a side of a road and performing analysis of traffic conditions including a traveling speed of each of vehicles traveling on the road; unit price determining means for determining a unit price of an advertisement to be displayed on an advertisement display apparatus that is installed in such a way that it is viewable from the vehicles traveling on the road; and advertising rate calculation means for calculating an advertising rate based on a track record of the advertisement displayed on the advertisement display apparatus and the unit price determined by the unit price determining means.

The present disclosure provides an advertisement distribution system. An advertisement distribution system includes: an advertisement display apparatus installed in such a way that it is viewable from vehicles traveling on a road; a sensor installed along a side of the road; and an advertisement distribution apparatus configured display an advertisement on the advertisement display apparatus. The advertisement distribution apparatus comprises analyzing means for obtaining sensor information from the sensor installed along the side of the road and performing analysis of traffic conditions including a traveling speed of each of the vehicles traveling on the road; unit price determining means for determining a unit price of the advertisement to be displayed on the advertisement display apparatus based on the analyzed traffic conditions; and advertising rate calculation means for calculating an advertising rate based on a track record of the advertisement displayed on the advertisement display apparatus and the unit price determined by the unit price determining means.

The present disclosure provides an advertisement distribution method. An advertisement distribution method includes: determining an advertisement to be displayed on an advertisement display apparatus that is installed in such a way that it is viewable from vehicles traveling on a road; obtaining sensor information from a sensor installed along a side of the road and performing analysis of traffic conditions including a traveling speed of each of the vehicles traveling on the road; determining, based on the analyzed traffic conditions, a unit price of the advertisement to be displayed on the advertisement display apparatus; and calculating an advertising rate based on a track record of the advertisement displayed on the advertisement display apparatus and the determined unit price.

The present disclosure provides an advertisement rate determination method. An advertisement rate determination method includes: obtaining sensor information from a sensor installed along a side of a road and performing analysis of traffic conditions including a traveling speed of each of vehicles traveling on the road; determining, based on the analyzed traffic conditions, a unit price of an advertisement to be displayed on an advertisement display apparatus that is installed in such a way that it is viewable from the vehicles traveling on the road; and calculating an advertising rate based on a track record of the advertisement displayed on the advertisement display apparatus and the determined unit price.

The present disclosure provides a computer readable medium. A computer readable medium stores a program for causing a computer to execute processes of: determining an advertisement to be displayed on an advertisement display apparatus that is installed in such a way that it is viewable from vehicles traveling on a road; obtaining sensor information from a sensor installed along a side of the road and performing analysis of traffic conditions including a traveling speed of each of the vehicles traveling on the road; determining, based on the analyzed traffic conditions, a unit price of the advertisement to be displayed on the advertisement display apparatus; and calculating an advertising rate based on a track record of the advertisement displayed on the advertisement display apparatus and the determined unit price.

The present disclosure provides a computer readable medium. A computer readable medium stores a program for causing a computer to execute processes of: obtaining sensor information from a sensor installed along a road and performing analysis of traffic conditions including a traveling speed of each of the vehicles traveling on the road; determining, based on the analyzed traffic conditions, a unit price of the advertisement to be displayed on the advertisement display apparatus installed along a side of the road in such a way that it is viewable from vehicles traveling on a road; and calculating an advertising rate based on a track record of the advertisement displayed on the advertisement display apparatus and the determined unit price.

### Advantageous Effects of Invention

According to the present disclosure, an advertisement distribution system, an advertisement distribution apparatus, an advertising rate determination apparatus, a method, and a computer-readable medium are each adapted to enable determination of advertising rates based on the traveling speed of vehicles.

### BRIEF DESCRIPTION OF DRAWINGS

FIG. 1 is a block diagram showing an advertisement distribution system;

FIG. 2 is a block diagram showing a schematic configuration of an advertisement distribution apparatus;

FIG. 3 is a block diagram showing an advertisement distribution system according to an example embodiment of the present disclosure;

FIG. 4 is a block diagram showing a configuration example of an advertisement distribution apparatus;

FIG. 5 is a diagram showing an example of a table used in determination of advertisements to be displayed;

FIG. 6 is a flowchart showing an operating procedure of an advertisement distribution apparatus; and

FIG. 7 is a block diagram showing a configuration example of a computing device.

### EXAMPLE EMBODIMENT

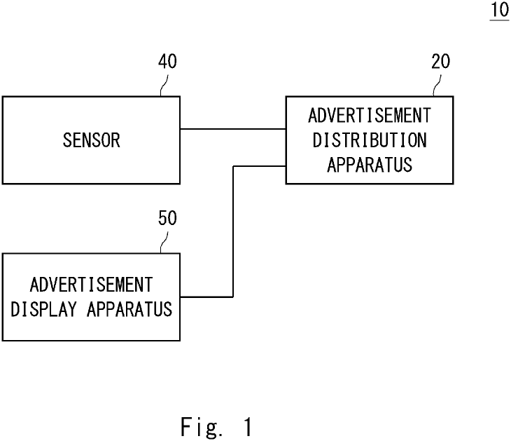

An overview of the present disclosure is described prior to the description of example embodiments thereof. FIG. 1 shows an advertisement distribution system according to the present disclosure. An advertisement distribution system 10 includes an advertisement distribution apparatus 20, a sensor 40, and an advertisement display apparatus 50. The advertisement display apparatus 50 is an apparatus for displaying advertisements and is installed in such a way that it is viewable from vehicles traveling on the road. The sensor 40 is installed on a road and outputs sensor information.

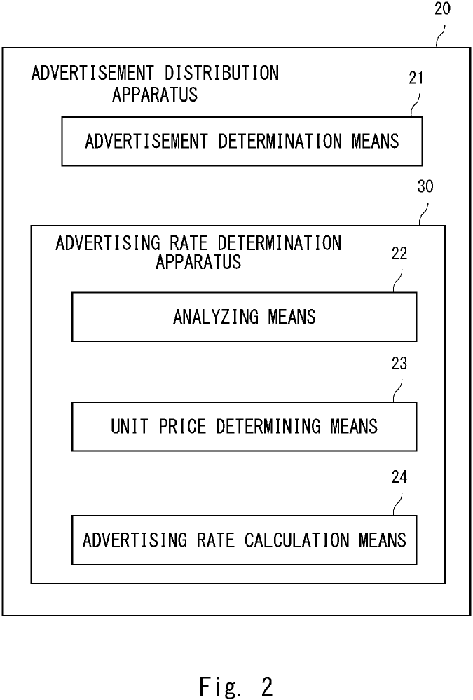

FIG. 2 shows a schematic configuration of the advertisement distribution apparatus 20. The advertisement distribution apparatus 20 includes advertisement determination means 21, analyzing means 22, unit price determining means 23, and advertising rate calculation means 24. The analyzing means 22, unit price determining means 23, and advertising rate calculation means 24 configure an advertising rate determination apparatus 30.

The advertisement determination means 21 determines which advertisement to be displayed on the advertisement display apparatus 50. The analyzing means 22 obtains the sensor information from the sensor 40 and performs analysis of the traffic conditions including the traveling speed of vehicles on a road. The unit price determining means 23 determines the unit price for displaying an advertisement on the advertisement display apparatus 50 based on the analyzed traffic conditions. The advertising rate calculation means 24 calculates the advertising rate of an advertisement based on the track record of an advertisement displayed on the advertisement display apparatus 50 and the unit price determined by the unit price determining means 23.

In the present disclosure, the analyzing means 22 performs analysis of the traffic conditions including the traveling speed of vehicles on a road. The unit price determining means 23 determines the unit price for displaying an advertisement based on the analyzed traffic conditions including the traveling speed of vehicles on a road. The advertising rate calculation means 24 calculates the advertising rate based on the determined unit price. In the present disclosure, in calculating the advertising rate, the traveling speed of vehicles on a road is used. For example, in the case where a vehicle is traveling at a low speed, occupant of the vehicle can get a good look at an advertisement, and therefore it is highly worth displaying an advertisement. On the other hand, in the case where a vehicle is traveling at a high speed, the vehicle quickly passes by the advertisement display apparatus, and therefore it is less worth displaying an advertisement. In the present disclosure, since the traveling speed of vehicles on a road is used for calculation of the advertising rate, the advertisement distribution apparatus 20 (the advertising rate determination apparatus 30) can calculate the advertising rate based on how much display of the advertisement is worth.

Note that in the aforementioned description, an example has been described in which the advertisement distribution apparatus 20 includes the advertising rate determination apparatus 30, but the present disclosure is not limited thereto. The advertising rate determination apparatus 30 does not need to be included in an apparatus that determines the advertisement to be displayed on the advertisement display apparatus 50 and may be configured separately from such an apparatus that determines the advertisement to be displayed on the advertisement display apparatus 50.

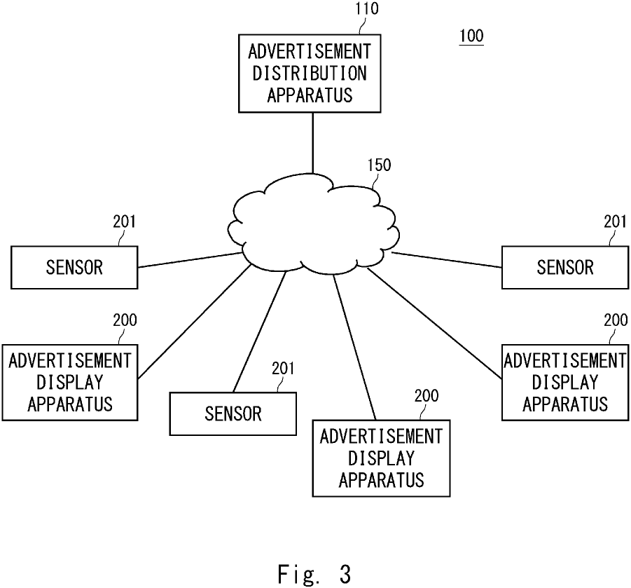

Hereinbelow, example embodiments of the present disclosure will be described in detail. FIG. 3 shows an advertisement distribution system according to an example embodiment of the present disclosure. An advertisement distribution system 100 includes an advertisement distribution apparatus 110, at least one advertisement display apparatus 200, and at least one sensor 201. The advertisement distribution apparatus 110, the advertisement display apparatus 200, and the sensor 201 are connected with one another via, for example, a network 150. The network 150 includes, for example, a wireless network and a wired network. The advertisement distribution apparatus 110 corresponds to the advertisement distribution apparatus 20 shown in FIG. 1.

The advertisement display apparatus 200 is an apparatus such as a digital signage for displaying advertisement. The advertisement display apparatus 200 includes, for example, a display device and a communication interface. The advertisement display apparatus 200 is located in such a way that it is viewable from vehicles traveling on a road. The advertisement display apparatus 200 is installed for example, on the left side of road of a left-hand traffic. The advertisement display apparatus 200 may be installed at intersections. The advertisement display apparatus 200 may be co-located together with other objects installed along a side of a road. The advertisement display apparatus 200 corresponds to the advertisement display apparatus 50 shown in FIG. 1

The sensor 201 is installed on a road and outputs sensor information. The sensor 201 includes, for example, a camera that captures images of vehicles traveling on a road. The sensor 201 captures an image of, for example, a road where the advertisement display apparatus 200 is installed. The sensor 201 may be attached to the advertisement display apparatus 200 or may be incorporated in the advertisement display apparatus 200. The sensor 201 transmits the video it has taken to the advertisement distribution apparatus 110. The sensor 201 corresponds to the sensor 40 shown in FIG. 1.

Note that in FIG. 1, an example in which the advertisement distribution system 100 includes three advertisement display apparatuses 200 and three sensors 201 is shown, but the present disclosure is not limited thereto. The advertisement distribution system 100 may include any number of the advertisement display apparatuses 200 and the sensors 201. Further, the number of the advertisement display apparatuses 200 and the number of the sensors 201 do not necessarily have to be the same.

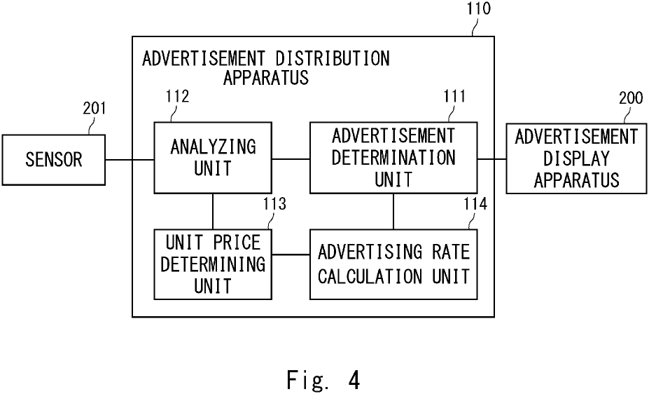

FIG. 4 is diagram showing a configuration example of an advertisement distribution apparatus 110. The advertisement distribution apparatus 110 includes an advertisement determination unit 111, an analyzing unit 112, a unit price determining unit 113, and an advertising rate calculation unit 114. The analyzing unit 112 obtains the sensor information from the sensor 201 and performs analysis of the traffic conditions of a road. The traffic conditions include traveling speed of vehicles on a road (vehicle speed). The analyzing unit 112 performs analysis of the traveling speed of each of the vehicles, for example, for a period during which an advertisement is displayed on the advertisement display apparatus 200. The analyzing unit 112 may further analyze the number of vehicles traveling on a road and/or the number of occupants of each of the vehicles. The analyzing unit 112 may further analyze at least one of the type or the manufacturer of each vehicle traveling on a road. The analyzing unit 112 corresponds to the analyzing means 22 shown in FIG. 2.

The advertisement determination unit 111 determines the advertisement to be displayed on the advertisement display apparatus 200. The advertisement determination unit 111 may determine an advertisement to be displayed based on at least one of the type and the manufacturer of a vehicle analyzed by the analyzing unit 112. For example, the advertisement determination unit 111 has a table in which at least one of the type and the manufacturer of each vehicle is stored in association with the genres of the advertisements. The advertisement determination unit 111 may refer to the table and determine the advertisement of the genre corresponding to the type of and the manufacturer of the vehicle for which analysis have been performed as the advertisement to be displayed on the advertisement display apparatus 200. In this case, the advertisement display apparatus 200 can display an advertisement suited for a target audience. The advertisement determination unit 111 corresponds to the advertisement determination means 21 shown in FIG. 2.

The unit price determining unit 113 determines the unit price for displaying an advertisement on the advertisement display apparatus 200 based on the traffic conditions analyzed by the analyzing unit 112. The unit price determining unit 113 determines the unit price for displaying an advertisement on the advertisement display apparatus 200 based on, for example, the track record of the advertisement displayed on the advertisement display apparatus 200 and the analyzed traveling speed of each of the vehicles. The track record of an advertisement includes, for example, the number of times an advertisement is displayed or the time of day the advertisement is displayed. The unit price determining unit 113 may determine the unit price for displaying an advertisement based on the track record of the advertisement and the traveling speed and the number of vehicles traveling on the road. Further, the unit price determining unit 113 may determine the unit price for displaying an advertisement based on the track record of the advertisement and the traveling speed and the number of occupants of vehicles traveling on the road. The unit price determining unit 113 corresponds to the unit price determining means 23 shown in FIG. 2.

The advertising rate calculation unit 114 calculates the advertising rate based on the track record of an advertisement displayed on the advertisement display apparatus and the unit price determined by the unit price determining unit 113. The advertising rate calculation unit 114 calculates an advertising rate for a plurality of advertisements based on the track record of display of the respective advertisements and the unit price for displaying the respective advertisements. The advertising rate calculation unit 114 calculates the product of the number of times an advertisement is displayed in a given period of time, for example, one month or one week, and the unit price for displaying an advertisement as the advertising rate. Alternatively, the advertising rate calculation unit 114 calculates the product of time an advertisement is displayed and the unit price (hourly rate) for displaying the advertisement as the advertising rate. The advertising rate calculation unit 114 corresponds to the advertising rate calculation means 24 shown in FIG. 2.

Here, in the case where a vehicle is traveling at a low speed, the vehicle occupant can take a good look at an advertisement displayed on the advertisement display apparatus 200. Therefore, in the case where a vehicle is traveling at a low speed, it is highly worth displaying an advertisement. On the other hand, in the case where a vehicle is traveling at a high speed, the vehicle quickly passes by the advertisement display apparatus 200. Therefore, the time during which an occupant of a vehicle can take a look at an advertisement displayed on the advertisement display apparatus 200 is short, and therefore it is less worth displaying an advertisement. Further, in the case where there is few number of vehicles traveling on the road where the advertisement display apparatus 200 is installed or few number of occupants of the vehicles traveling on the road, few people will look at the advertisement, and therefore it is less worth displaying an advertisement. On the other hand, in the case where the number vehicles traveling on the road where the advertisement display apparatus 200 is installed or the number of occupants of the vehicles traveling on the road is large, many people will look at the advertisement, and therefore it is highly worth displaying an advertisement.

In the present example embodiment, the analyzing unit 112 performs analysis of the traffic conditions for a period during which an advertisement is displayed, for example, the traveling speed of vehicles, the number of vehicles (the traffic volume), and the number of occupants of vehicles. The unit price determining unit 113 determines the unit price for displaying an advertisement based on the speed and the number of vehicles. The unit price determining unit 113 varies the unit price based on, for example, speed of vehicles. For example, the unit price determining unit 113 sets the unit price low in the case a vehicle is traveling at a high speed and the sets the unit price high in the case a vehicle is traveling at a low speed. Further, in the case where there is few number vehicles or few number of occupants of vehicles, few people will look at the advertisement, and therefore the unit price determining unit 113 sets the unit price for displaying an advertisement low. In the case where the number of vehicles or the number of occupants of vehicles is large, a large number of people will look at the advertisement, and therefore the unit price determining unit 113 sets the unit price for displaying an advertisement high.

Further, in the present example embodiment, the analyzing unit 112 performs analysis of the type of the vehicle traveling on the road where the advertisement display apparatus 200 is installed. The analyzing unit 112 analyzes (identifies) the type of a vehicle, such as a high-end vehicle, tram, a tour bus, or the like, based on the sensor information obtained from a camera or other sensors. The advertisement determination unit 111 determines the advertisement to be displayed on the advertisement display apparatus 200 based on the types of vehicles analyzed by the analyzing unit 112. For example, in the case where there are a large number of high-end vehicles among the vehicles traveling on the road where the advertisement display apparatus 200 is installed, the advertisement determination unit 111 determines an advertisement targeted for high-income class to be displayed on the advertisement display apparatus 200.

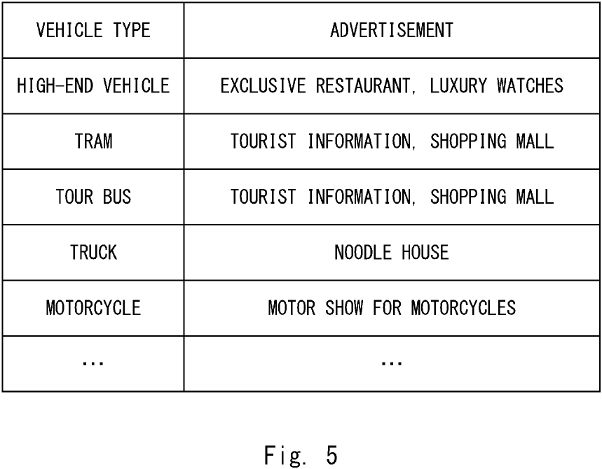

FIG. 5 shows an example of a table used in determination of advertisements to be displayed. The table stores the type of each vehicle (vehicle type) in association with the genres (types) of the advertisements. In FIG. 5, the vehicle type “high-end vehicle” is associated with “exclusive restaurants” and “luxury watches”. The vehicle type “tram” and the vehicle type “tour bus” are associated with “tourist information” and “shopping mall”, respectively. The vehicle type “truck” is associated with “noodle house” and the vehicle type “motorcycle” is associated with “motor show of motorcycles”.

In the case where it is analyzed by the analyzing unit 112 that the vehicle traveling on the road is a high-end vehicle, the advertisement determination unit 111 selects the advertisement registered in an unillustrated advertisement database in association with “exclusive restaurants” or “luxury watches” as the advertisement to be displayed. In the case where it is analyzed by the analyzing unit 112 that the vehicle traveling on the road is a tour bus, the advertisement determination unit 111 selects an advertisement registered in the advertisement database in association with “tourist information” or “shopping mall” as the advertisement to be displayed. The advertisement determination unit 111 may transmit the contents of the advertisement which has been selected to the advertisement display apparatus 200 via the network 150 (see, FIG. 3). In the case where the contents of an advertisement is stored in the advertisement display apparatus 200, the advertisement determination unit 111 may transmit an identifier of the selected advertisement to the advertisement display apparatus 200 and make the advertisement display apparatus 200 display an advertisement corresponding to the identifier.

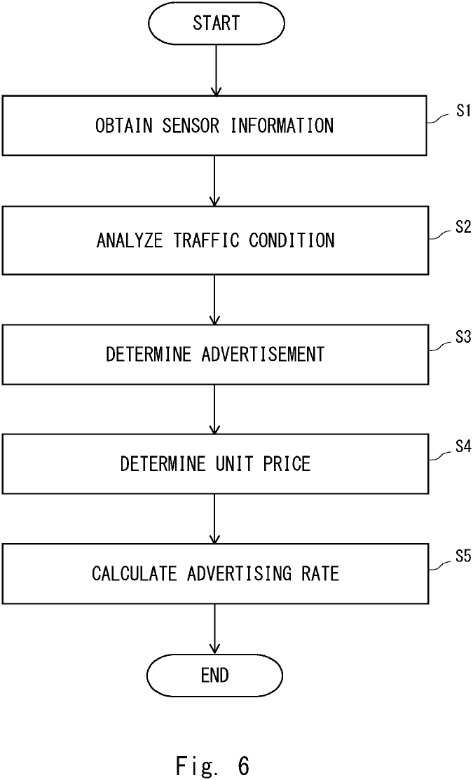

Next, an operating procedure of an advertisement distribution apparatus will be described. FIG. 6 is a flowchart showing an operating procedure of an advertisement distribution apparatus 110 (an advertisement distribution method) including determination of advertising rates (advertising rate determination method). The analyzing unit 112 obtains the sensor information from the sensor 201 (Step S1). The analyzing unit 112 performs analysis of the traffic condition of a road based on the sensor information (Step S2). In Step S2, the analyzing unit 112 performs analysis of the speed of vehicles traveling on a road. In Step S2, the analyzing unit 112 may further analyze the number of the vehicles, the types of the vehicles, the manufacturer of the vehicles, and the number of occupants of the vehicles.

The advertisement determination unit 111 determines the advertisement displayed on advertisement display apparatus 200 (Step S3). In Step S3, the advertisement determination unit 111 may determine an advertisement to be displayed based on the type and the manufacturer of a vehicle analyzed in Step S2. The unit price determining unit 113 determines a unit price for displaying an advertisement on the advertisement display apparatus 200 based on the traffic conditions analyzed by the analyzing unit 112 (Step S4). The slower the speed of vehicles and the larger the number of vehicles in Step S4, the higher the unit price may be set by the unit price determining unit 113.

The advertising rate calculation unit 114 calculates the advertising rate based on the track record of an advertisement displayed on the advertisement display apparatus and the unit price determined by the unit price determining unit 113 (Step S5). In Step S5, the advertising rate calculation unit 114 calculates, for example, the product of time an advertisement is displayed and the unit price for displaying the advertisement determined in Step S4 as the advertising rate.

In the present example embodiment, the analyzing unit 112 performs analysis of the traffic conditions including vehicle speed. The unit price determining unit 113 determines the unit price of an advertisement based on the analyzed traffic conditions. The unit price determining unit 113 sets the unit price low in the case a vehicle is traveling at a high speed and the sets the unit price high in the case a vehicle is traveling at a low speed. In this case, the unit price for an advertisement which a vehicle occupant cannot take a good look at can be set low and the unit price for an advertisement which a vehicle occupant can take a good look at can be set high. As described above, in the present example embodiment, the advertising rates are determined according to the advertising effect and therefore an advertising sponsor who wants to place an advertisement on the advertisement display apparatus 200 can pay for displaying an advertisement according to the effectiveness of the displayed advertisement.

Note that in the aforementioned example embodiment, the advertisement determination unit 111 may link a plurality of advertisement display apparatuses 200 installed along a side of a road and an advertisement may be displayed on the plurality of advertisement display apparatuses 200. In this case, the advertisement determination unit 111 may determine an advertisement to be displayed on the plurality of advertisement display apparatuses 200 and the timing at which the advertisement is displayed. For example, the advertisement determination unit 111 may divide one advertising content into a plurality of pieces corresponding to the plurality of advertisement display apparatuses 200, and the timing of display of the respective pieces of the advertising content by each advertisement display apparatus 200 may be controlled according to the movement of a vehicle. Alternatively, the advertisement determination unit 111 may make the plurality of advertisement display apparatuses 200 display a series of advertisements configured of a plurality advertising contents according to the movement of a vehicle.

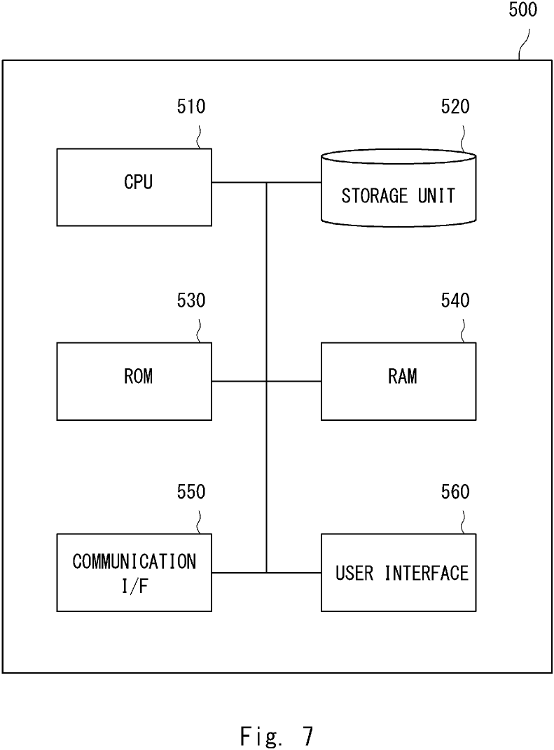

In the present disclosure, the advertisement distribution apparatus 110 can be configured using a computing device (a server device). FIG. 7 shows a configuration example of a computing device that is applicable for the advertisement distribution apparatus 110. The computing device 500 includes a control unit (CPU: Central Processing Unit) 510, a storage unit 520, a ROM (Read Only Memory) 530, a RAM (Random Access Memory) 540, a communication interface (IF: Interface) 550, and a user interface 560.

The communication interface 550 is an interface for the communication device 500 and the communication network via wired communication means or wireless communication means. The user interface 560 includes a display unit, such as a display. Further, the user interface 560 includes an input unit such as a keyboard, a mouse, and a touch panel.

The storage unit 520 is an auxiliary device capable of holding various data. The storage unit 520 does not have to a part of the computer device 500 and may be an external storage device, or it may be a cloud storage connected to the computer device 500 via a network.

The ROM 530 is a non-volatile storage device. A semiconductor storage device such as a flash memory will relatively small capacity may be used for the ROM 530. A program to be executed by the CPU 510 can be stored in the storage device 520 or the ROM 530. The storage unit 520 or the ROM 530 stores, for example, various programs for realizing the functions of respective units in the advertisement distribution apparatus 110.

The aforementioned program can be stored and provided to the computer device 500 using any type of non-transitory computer readable media. Non-transitory computer readable media include any type of tangible storage media. Examples of non-transitory computer readable media include magnetic storage media such as floppy disks, magnetic tapes, hard disk drives, etc., optical magnetic storage media such as magneto-optical disks, CD (compact disc), and DVD (digital versatile disk), and semiconductor memories such as mask ROM, PROM (programmable ROM), EPROM (erasable PROM), flash ROM, and RAM (Random Access Memory). Further, the program may be provided to a computer using any type of transitory computer readable media. Examples of transitory computer readable media include electric signals, optical signals, and electromagnetic waves. Transitory computer readable media can provide the program to a computer via a wired communication line such as electric wires and optical fibers or a wireless communication line.

The RAM 540 is a volatile storage device. Various types of semiconductor devices such as DRAM (Dynamic Random Access Memory) and SRAM (Static Random Access Memory) are used for the RAM 540. The RAM 540 can be used an internal buffer that temporarily stores data and the like. The CPU 510 expands the program stored in the storage unit 520 or the ROM 530 to the RAM 540 and executes it. By having the CPU 510 execute the program, the functions of the units in the advertisement distribution apparatus 110 can be realized. The CPU 510 may include an internal buffer capable of temporarily storing data and the like.

The example embodiments of the present disclosure have been described above but the present disclosure is not limited to the above-described example embodiments, and changes or modifications that are made thereto without departing from the gist of the present disclosure are also included in the present disclosure.

The whole or part of the example embodiments disclosed above can be described as, but not limited to, the following supplementary notes.

### Supplementary Note 1

An advertisement distribution apparatus comprising:
advertisement determination means for determining an advertisement to be displayed on an advertisement display apparatus that is installed in such a way that it is viewable from vehicles traveling on a road;
analyzing means for obtaining sensor information from a sensor installed along a side of the road and performing analysis of traffic conditions including a traveling speed of each of the vehicles traveling on the road;
unit price determining means for determining, based on the analyzed traffic conditions, a unit price of the advertisement to be displayed on the advertisement display apparatus; and
advertising rate calculation means for calculating an advertising rate based on a track record of the advertisement displayed on the advertisement display apparatus and the unit price determined by the unit price determining means.

### Supplementary Note 2

The advertisement distribution apparatus described in Supplementary Note 1, wherein
the analyzing means performs analysis of the traveling speed of each of the vehicles for a period during which the advertisement is displayed, and
the unit price determining means determines the unit price of the advertisement displayed on the advertisement display apparatus based on the track record of the displayed advertisement and the traveling speed of each of the vehicles.

### Supplementary Note 3

The advertisement distribution apparatus described in Supplementary Note 2, wherein
the analyzing means further performs analysis of the number of the vehicles traveling on the road, and
the unit price determining means determines the unit price of the advertisement displayed on the advertisement display apparatus based on the track record of the displayed advertisement and the traveling speed of each of the vehicles and the number of the vehicles traveling on the road.

### Supplementary Note 4

The advertisement distribution apparatus described in Supplementary Note 2, wherein
the analyzing means further performs analysis of occupants of each of the vehicles, and
the unit price determining means determines the unit price of the advertisement displayed on the advertisement display apparatus based on the track record of the displayed advertisement and the traveling speed and the occupants of each of the vehicles traveling on the road.

### Supplementary Note 5

The advertisement distribution apparatus described in any one of Supplementary Notes 1 to 4, wherein
the analyzing means further performs analysis of a type and a manufacturer of each of the vehicles, and
the advertisement determination means determines the advertisement to be displayed based on at least one of a type and a manufacturer of each of the vehicles.

### Supplementary Note 6

The advertisement distribution apparatus described Supplementary Note 5, wherein the advertisement determination means refers to a table that stores the type and the manufacturer of each of the vehicles in association with a genre of the advertisement and determines an advertisement of the genre corresponding to the type and the manufacturer of each of the vehicles as the advertisement to be displayed on the advertisement display apparatus.

### Supplementary Note 7

The advertisement distribution apparatus described in any one Supplementary Notes 1 to 6, wherein the advertisement determination means determines, based on the traveling speed of each of the vehicles, the advertisement to be displayed on a plurality of the advertisement display apparatuses installed along the side of the road and the timing of display of the advertisement.

### Supplementary Note 8

An advertising rate determination apparatus comprising:
analyzing means for obtaining sensor information from a sensor installed along a side of a road and performing analysis of traffic conditions including a traveling speed of each of vehicles traveling on the road;
unit price determining means for determining a unit price of an advertisement to be displayed on an advertisement display apparatus that is installed in such a way that it is viewable from the vehicles traveling on the road; and
advertising rate calculation means for calculating an advertising rate based on a track record of the advertisement displayed on the advertisement display apparatus and the unit price determined by the unit price determining means.

### Supplementary Note 9

An advertising rate determination apparatus described in Supplementary Note 8, wherein
the analyzing means performs analysis of the traveling speed of each of the vehicles for a period during which the advertisement is displayed, and
the unit price determining means determines the unit price of the advertisement displayed on the advertisement display apparatus based on the track record of the displayed advertisement and the traveling speed of each of the vehicles.

### Supplementary Note 10

The advertising rate determination apparatus described in Supplementary Note 9, wherein
the analyzing means further performs analysis of the number of the vehicles, and
the unit price determining means determines the unit price of the advertisement displayed on the advertisement display apparatus based on the track record of the displayed advertisement and the traveling speed and the number of the vehicles traveling on the road.

### Supplementary Note 11

The advertising rate determination apparatus described in Supplementary Note 9, wherein
the analyzing means further performs analysis of occupants of each of the vehicles, and
the unit price determining means determines the unit price of the advertisement displayed on the advertisement display apparatus based on the track record of the displayed advertisement and the traveling speed and the occupants of each of the vehicles traveling on the road.

### Supplementary Note 12

An advertisement distribution system comprising:
an advertisement display apparatus installed in such a way that it is viewable from vehicles traveling on a road;
a sensor installed along a side of the road; and
an advertisement distribution apparatus configured display an advertisement on the advertisement display apparatus,
wherein the advertisement distribution apparatus comprises:
   analyzing means for obtaining sensor information from the sensor installed along the side of the road and performing analysis of traffic conditions including a traveling speed of each of the vehicles traveling on the road;
   unit price determining means for determining a unit price of the advertisement to be displayed on the advertisement display apparatus based on the analyzed traffic conditions; and
   advertising rate calculation means for calculating an advertising rate based on a track record of the advertisement displayed on the advertisement display apparatus and the unit price determined by the unit price determining means.

### Supplementary Note 13

The advertisement distribution system described in Supplementary Note 12, wherein
the analyzing means performs analysis of the traveling speed of each of the vehicles for a period during which the advertisement is displayed, and
the unit price determining means determines the unit price of the advertisement displayed on the advertisement display apparatus based on the track record of the displayed advertisement and the traveling speed of each of the vehicles.

### Supplementary Note 14

The advertisement distribution system described in Supplementary Note 13, wherein
the analyzing means further performs analysis of the number of the vehicles, and
the unit price determining means determines the unit price of the advertisement displayed on the advertisement display apparatus based on the track record of the displayed advertisement and the traveling speed and the number of the vehicles traveling on the road.

### Supplementary Note 15

The advertisement distribution system described in Supplementary Note 13, wherein
the analyzing means further performs analysis of occupants of each of the vehicles, and
the unit price determining means determines the unit price of the advertisement displayed on the advertisement display apparatus based on the track record of the displayed advertisement and the traveling speed and the occupants of each of the vehicles traveling on the road.

### Supplementary Note 16

An advertisement distribution method comprising:
determining an advertisement to be displayed on an advertisement display apparatus that is installed in such a way that it is viewable from vehicles traveling on a road;
obtaining sensor information from a sensor installed along a side of the road and performing analysis of traffic conditions including a traveling speed of each of the vehicles traveling on the road;
determining, based on the analyzed traffic conditions, a unit price of the advertisement to be displayed on the advertisement display apparatus; and
calculating an advertising rate based on a track record of the advertisement displayed on the advertisement display apparatus and the determined unit price.

### Supplementary Note 17

An advertisement rate determination method comprising:
obtaining sensor information from a sensor installed along a side of a road and performing analysis of traffic conditions including a traveling speed of each of vehicles traveling on the road;
determining, based on the analyzed traffic conditions, a unit price of an advertisement to be displayed on an advertisement display apparatus that is installed in such a way that it is viewable from the vehicles traveling on the road; and
calculating an advertising rate based on a track record of the advertisement displayed on the advertisement display apparatus and the determined unit price.

### Supplementary Note 18

A non-transitory computer readable medium storing a program for causing a computer to execute processes of:
determining an advertisement to be displayed on an advertisement display apparatus that is installed in such a way that it is viewable from vehicles traveling on a road;
obtaining sensor information from a sensor installed along a side of the road and performing analysis of traffic conditions including a traveling speed of each of the vehicles traveling on the road;
determining, based on the analyzed traffic conditions, a unit price of the advertisement to be displayed on the advertisement display apparatus; and
calculating an advertising rate based on a track record of the advertisement displayed on the advertisement display apparatus and the determined unit price.

### Supplementary Note 19

A non-transitory computer readable medium storing a program for causing a computer to execute processes of:
obtaining sensor information from a sensor installed along a side of a road and performing analysis of traffic conditions including a traveling speed of each of the vehicles traveling on the road;
determining, based on the analyzed traffic conditions, a unit price of the advertisement to be displayed on the advertisement display apparatus installed along a side of the road in such a way that it is viewable from vehicles traveling on a road; and
calculating an advertising rate based on a track record of the advertisement displayed on the advertisement display apparatus and the determined unit price.

### REFERENCE SIGNS LIST

10: ADVERTISEMENT DISTRIBUTION SYSTEM
20: ADVERTISEMENT DISTRIBUTION APPARATUS
21: ADVERTISEMENT DETERMINATION MEANS
22: ANALYZING MEANS
23: UNIT PRICE DETERMINING MEANS
24: ADVERTISING RATE CALCULATION MEANS
30: ADVERTISING RATE DETERMINATION APPARATUS
40: SENSOR
50: ADVERTISEMENT DISPLAY APPARATUS
100: ADVERTISEMENT DISTRIBUTION SYSTEM
110: ADVERTISEMENT DISTRIBUTION APPARATUS
111: ADVERTISEMENT DETERMINATION UNIT
112: ANALYZING UNIT
113: UNIT PRICE DETERMINING UNIT
114: ADVERTISING RATE CALCULATION UNIT
150: NETWORK
200: ADVERTISEMENT DISPLAY APPARATUS
201: SENSOR

What is claimed is:

1. An advertisement distribution apparatus comprising:
at least one memory storing instructions; and
at least one processor configured to execute the instructions to:
determine an advertisement to be displayed on an advertisement display apparatus that is installed in such a way that it is viewable from vehicles traveling on a road;
obtain sensor information from a sensor installed along a side of the road and perform analysis of traffic conditions including a traveling speed of each of the vehicles traveling on the road;
determine, based on the analyzed traffic conditions, a unit price of the advertisement to be displayed on the advertisement display apparatus; and
calculate an advertising rate based on a track record of the advertisement displayed on the advertisement display apparatus and the determined unit price.

2. The advertisement distribution apparatus according to claim 1, wherein
the at least one processor is configured to execute the instructions to:
perform analysis of the traveling speed of each of the vehicles for a period during which the advertisement is displayed, and
determine the unit price of the advertisement displayed on the advertisement display apparatus based on the track record of the displayed advertisement and the traveling speed of each of the vehicles.

3. The advertisement distribution apparatus according to claim 2, wherein
the at least one processor is further configured to execute the instructions to perform analysis of the number of the vehicles traveling on the road, and
the at least one processor is configured to execute the instructions to determine the unit price of the advertisement displayed on the advertisement display apparatus based on the track record of the displayed advertisement and the traveling speed of each of the vehicles and the number of the vehicles traveling on the road.

4. The advertisement distribution apparatus according to claim 2, wherein
the at least one processor is further configured to execute the instructions to perform analysis of occupants of each of the vehicles, and
the at least one processor is configured to execute the instructions to determine the unit price of the advertisement displayed on the advertisement display apparatus based on the track record of the displayed advertisement and the traveling speed and the occupants of each of the vehicles traveling on the road.

5. The advertisement distribution apparatus according to claim 1, wherein
the at least one processor is further configured to execute the instructions to perform analysis of a type and a manufacturer of each of the vehicles, and
the at least one processor is configured to execute the instructions to determine the advertisement to be displayed based on at least one of a type and a manufacturer of each of the vehicles.

6. The advertisement distribution apparatus according to claim 5, wherein the at least one processor is configured to execute the instructions to refer to a table that stores the type and the manufacturer of each of the vehicles in association with a genre of the advertisement and determine an advertisement of the genre corresponding to the type and the manufacturer of each of the vehicles as the advertisement to be displayed on the advertisement display apparatus.

7. The advertisement distribution apparatus according to claim 1, wherein the at least one processor is configured to execute the instructions to determine, based on the traveling speed of each of the vehicles, the advertisement to be displayed on a plurality of the advertisement display apparatuses installed along the side of the road and the timing of display of the advertisement.

8. An advertising rate determination apparatus comprising:
at least one memory storing instructions; and
at least one processor configured to execute the instructions to:
obtain sensor information from a sensor installed along a side of a road and perform analysis of traffic conditions including a traveling speed of each of vehicles traveling on the road;
determine a unit price of an advertisement to be displayed on an advertisement display apparatus that is installed in such a way that it is viewable from the vehicles traveling on the road; and
calculate an advertising rate based on a track record of the advertisement displayed on the advertisement display apparatus and the determined unit price.

9. An advertising rate determination apparatus according to claim 8, wherein
the at least one processor is configured to execute the instructions to:
perform analysis of the traveling speed of each of the vehicles for a period during which the advertisement is displayed, and
determine the unit price of the advertisement displayed on the advertisement display apparatus based on the track record of the displayed advertisement and the traveling speed of each of the vehicles.

10. The advertising rate determination apparatus according to claim 9, wherein
the at least one processor is further configured to execute the instructions to perform analysis of the number of the vehicles, and
the at least one processor is configured to execute the instructions to determine the unit price of the advertisement displayed on the advertisement display apparatus based on the track record of the displayed advertisement and the traveling speed and the number of the vehicles traveling on the road.

11. The advertising rate determination apparatus according to claim 9, wherein
the at least one processor is further configured to execute the instructions to perform analysis of occupants of each of the vehicles, and
the at least one processor is configured to execute the instructions to determine the unit price of the advertisement displayed on the advertisement display apparatus based on the track record of the displayed advertisement and the traveling speed and the occupants of each of the vehicles traveling on the road.

12. An advertisement distribution system comprising:
an advertisement display apparatus installed in such a way that it is viewable from vehicles traveling on a road;
a sensor installed along a side of the road; and
an advertisement distribution apparatus according to claim 1.

13. The advertisement distribution system according to claim 12, wherein
the at least one processor is configured to execute the instructions to:
perform analysis of the traveling speed of each of the vehicles for a period during which the advertisement is displayed, and
determine the unit price of the advertisement displayed on the advertisement display apparatus based on the track record of the displayed advertisement and the traveling speed of each of the vehicles.

14. The advertisement distribution system according to claim 13, wherein
the at least one processor is further configured to execute the instructions to perform analysis of the number of the vehicles, and
the at least one processor is configured to execute the instructions to determine the unit price of the advertisement displayed on the advertisement display apparatus based on the track record of the displayed advertisement and the traveling speed and the number of the vehicles traveling on the road.

15. The advertisement distribution system according to claim 13, wherein
the at least one processor is further configured to execute the instructions to perform analysis of occupants of each of the vehicles, and
the at least one processor is configured to execute the instructions to determine the unit price of the advertisement displayed on the advertisement display apparatus based on the track record of the displayed advertisement and the traveling speed and the occupants of each of the vehicles traveling on the road.

16. An advertisement distribution method comprising:
determining an advertisement to be displayed on an advertisement display apparatus that is installed in such a way that it is viewable from vehicles traveling on a road;
obtaining sensor information from a sensor installed along a side of the road and performing analysis of traffic conditions including a traveling speed of each of the vehicles traveling on the road;
determining, based on the analyzed traffic conditions, a unit price of the advertisement to be displayed on the advertisement display apparatus; and
calculating an advertising rate based on a track record of the advertisement displayed on the advertisement display apparatus and the determined unit price.

17-19. (canceled)
